(19) United States
(12) Patent Application Publication
(10) Pub. No.: US 2016/0294806 A1
(43) Pub. Date: Oct. 6, 2016

(54) ACCOUNT INFORMATION MANAGEMENT METHOD AND APPARATUS IN SMART TV

(71) Applicant: LE SHI ZHI XIN ELECTRONIC TECHNOLOGY (TIANJIN) LIMITED, Beijing (CN)

(72) Inventors: Shuyin DU, Beijing (CN); Lei YAN, Beijing (CN)

(73) Assignee: LE SHI ZHI XIN ELECTRONIC TECHNOLOGY (TIANJIN) LIMITED, Beijing (CN)

(21) Appl. No.: 15/038,407

(22) PCT Filed: Nov. 20, 2014
(86) PCT No.: PCT/CN2014/091775

§ 371 Date: May 20, 2016

(30) Foreign Application Priority Data
Nov. 22, 2013 (CN) 201310590759.5

(51) Int. Cl. H04L 29/06

(52) U.S. Cl. CPC H04L 63/083

(57) ABSTRACT

A method includes: when a login request is received from a user, sending account information input by the user to a user center server of a smart TV for authentication; after the authentication succeeds and login is completed, receiving login information returned by the user center server and corresponding to the account information, and saving the login information in a preset database; and when the user enables a target application in the smart TV, receiving a login status query request sent by the target application, returning a response message to the target application, and notifying the target application that the current user has logged in, so that the target application acquires corresponding login information from the preset database, and completes a service request by using the login information. With the present disclosure, uniform account management on various applications in a smart TV can be achieved, thereby saving resources.

### FIELD OF TECHNOLOGY

The present disclosure relates to the field of smart TV technologies and in particular relates to an account information management method and apparatus in a smart TV.

### BACKGROUND

Under the circumstances of intelligence of personal computers (PC) and wide range of intelligence of mobile phone and tablet computers, smart TVs also enter out lives gradually to conform to the “high-definition”, “networking” and “intelligence” tendency of TVs.

The so-called smart TVs, just like smart phones, each have a full-open platform with an operating system. In addition to enjoying common TV contents, customers further can install and uninstall by themselves programs such as application software, games and so on provided by TV manufacturers or third-party service providers, such that functions of smart TVs can be continuously extended and upgraded through these programs. Additionally, smart TVs can be connected to networks, AV devices, PCs and so on, and further can acquire program contents from a plurality of channels such as networks, AV devices, PCs and so on, and clearly display contents most needed by users on TV screens through simple and easy-to-use integrated operation interfaces.

In a smart TV system, access to lots of applications, for example, TV edition, market, cloud service and the like of a smart TV, is based on accounts. In the prior art, different applications manage their own account systems; from the perspective of a user, the user needs to independently register in each application and remember his/her own information such as a user name and a password in each application to complete login. Hence, in the prior art, when various applications manage the respective account systems, respectively, many system resources need to be occupied and the implementation efficiency is also relatively low. As for the user, the user needs to memorize corresponding account information in various applications, which is complex, and mistakes are easy to make in this process.

### SUMMARY

Embodiments of the present disclosure provide an account information management method and apparatus in a smart TV, and one purpose thereof is to realize uniform account management for various applications in a smart TV, thereby saving resources and facilitating use of a user.

The embodiments of the present disclosure provide an account information management method in a smart TV, including:

when a login request is received from a user, sending account information input by the user to a user center server of a smart TV for authentication; wherein the account information includes information of a user name and a password;

after the authentication performed by the user center server succeeds and login is completed, receiving login information returned by the user center server and corresponding to the account information, and saving the login information in a preset database; wherein, the login information includes information of an access token, a user ID and a user name; and

when the user enables a target application in the smart TV, receiving a login status query request sent by the target application, returning a response message to the target application, and notifying the target application that the current user has logged in, so that the target application acquires corresponding login information from the preset database, and completes a service request by using the login information.

Preferably, the method further includes:

when a logout request is received from the user, sending a corresponding logout instruction to the user center server, and deleting the login information recorded in the database, and synchronously enabling the target application to log out.

Preferably, the method further includes:

when the login status query request sent by the target application is received, and if the current status is a non-login status, providing an operation entry for the user to input the account information and reminding the user of login.

Preferably, the method further includes:

pre-receiving a registration request and sending the account information input by the user to the user center server for saving.

Preferably, the method further includes:

when a request for modifying the account information is received, sending the modified account information to the user center server for saving.

Preferably, the target application includes a system level application of the smart TV, or an application-level application preinstalled in the smart TV, or a third-party application installed in the smart TV.

The embodiments of the present disclosure provide an account information management apparatus in a smart TV, including:

a login module configured to, when a login request is received from a user, send account information input by the user to a user center server of a smart TV for authentication; wherein the account information includes information of a user name and a password;

a login information saving module configured to, after the authentication performed by the user center server succeeds and login is completed, receive login information returned by the user center server and corresponding to the account information, and save the login information in a preset database; wherein, the login information includes information of an access token, a user ID and a user name; and

a query response module configured to, when the user enables a target application in the smart TV, receive a login status query request sent by the target application, return a response message to the target application, and notify the target application that the current user has logged in, so that the target application acquires corresponding login information from the preset database, and completes a service request by using the login information.

Preferably, the apparatus further includes:

a logout module configured to, when a logout request is received from the user, send a corresponding logout instruction to the user center server, and delete the login information recorded in the database, and synchronously enable the target application to log out.

Preferably, the apparatus further includes:

a reminding module configured to, when the login status query request sent by the target application is received, and if the current status is a non-login status, provide an operation entry for the user to input the account information and remind the user of login.

Preferably, the apparatus further includes:

a registration module configured to pre-receive a registration request and send the account information input by the user to the user center server for saving.

The embodiments of the present disclosure provide a computer-readable recording medium on which a program for executing any method of the embodiments of the present disclosure is recorded.

Compared with the prior art, one of the above-mentioned technical solutions has the following advantages or beneficial effects:

In the embodiments of the present disclosure, a system account application can be employed to perform uniform account management on various applications in a smart TV; as long as a user logs in to the system account application, the user equivalently has logged in to other associated applications synchronously. In this way, the various associated applications do not need to maintain and manage respective account systems independently, thereby saving resources; further, a user also does not need to remember account information in each application separately and thus can use various applications in the smart TV.

### BRIEF DESCRIPTION OF THE DRAWINGS

Those ordinary skilled in the art will know clearly various other advantages and benefits by reading brief descriptions of preferred embodiments below. Accompanying drawings are merely used for the purpose of illustrating the preferred embodiments rather than limiting the present disclosure. Moreover, in the whole drawings, the same parts are expressed by using the same reference signs.

In the accompanying drawings:

FIG. 1 is a flow diagram of an account information management method in a smart TV provided by an embodiment of the present disclosure;

FIG. 2 is a schematic diagram of an architecture of an account information management system provided by an embodiment of the present disclosure; and

FIG. 3 is a schematic diagram of an account information management apparatus in a smart TV provided by an embodiment of the present disclosure.

### DESCRIPTION OF THE EMBODIMENTS

To make the purposes, features and advantages of the present disclosure more obvious and understandable, the present disclosure is further described in detail below in combination with the accompanying drawings and specific embodiments.

First of all, it needs to be noted that, in the embodiments of the present disclosure, a special system account application can be provided to perform uniform account management on other various applications in a smart TV. In other words, the system account application is also an application running in the smart TV, functioning in providing an account management service for other applications. In this way, other various applications do not need to manage respective account systems independently, so that resources are saved; for a user, the user only needs to log in to the system account application once, so that automatic login of other various associated applications can be realized and login in each application does not need to be executed separately; moreover, information such as a user name and a password in each application also does not need to be recorded separately, and it thus is convenient for the user to use. Specific implementation solutions are described in detail below.

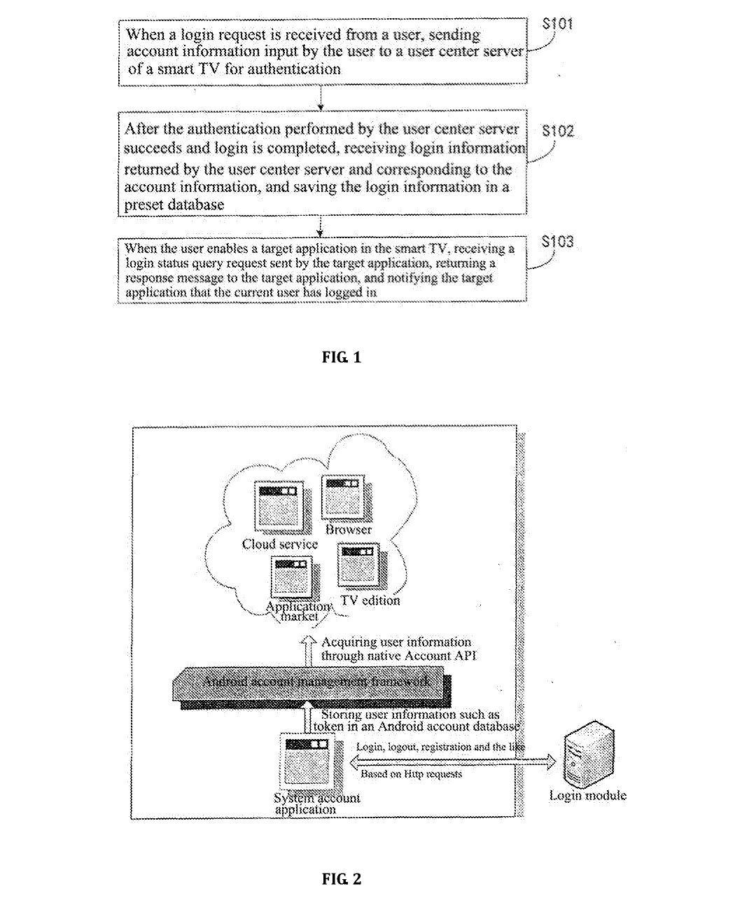

Referring to FIG. 1, the embodiments of the present disclosure firstly provide an account information management method in a smart TV, wherein an executive body of the method is the above-mentioned system account application; the method may include the following steps:

S101: when a login request is received from a user, account information input by the user is sent to a user center server of a smart TV for authentication; wherein the account information includes information of a user name and a password.

In the present embodiment of the present disclosure, the user only needs to log in to the system account application, so that other associated applications can completely respective service requests by directly using information after login. Hence, in specific implementation, the user firstly needs to log in to the system account application. Certainly, login is on the premise of registration; a registration process can be completed in advance; specifically, the system account application may provide the user with a corresponding user interface in which the user can input specific information such as a user name and a password, and then a system account application client may send the information input by the user to the user center server; next, the user center server allocates a user ID for the user, and therefore, the registration to the user information is completed. Then, the user can enter a login interface of the system account application to input his/her own account information including the user name, the password and the like, and the system account application client may submit the information input by the user to the user center server for authentication.

Wherein, the account information registered by the user may be modified; for example, the password can be modified; an operation entry for modifying the account information further can be provided for the user in the user interface of the system account information and the user can submit information such as a new password and so on through the entry; correspondingly, the system account application then may re-submit the modified account information to the user center server for saving, and subsequently, the user needs to log in by using the modified account information.

The so-called user center server is a server for uniformed management for the account information of a user; the account information registered by the user may be saved in the user center server, and the account information input by the user in the login process also needs to be authenticated by the user center server. After the authentication succeeds, an access token (token) may be generated. The access token is a kernel object of Windows, i.e., a protection object. When the user logs in to the user center server, a login process will authenticate a login credential (i.e., information such as the user name, the password and so on) submitted by the user; if the authentication succeeds, the login process will return an SID (Safety Identifier) corresponding to the user and a safety group SID list of the user. The user center server will generate an access token for the user who has logged in at present according to the information, and the token will be used for executing each thread and each process together with the user.

S102: after the authentication performed by the user center server succeeds and login is completed, login information returned by the user center server and corresponding to the account information is received, and the login information is stored in a preset database; wherein, the login information includes information of an access token, a user ID and a user name;

After login is completed and the access token is generated, the user center server may return the information of the access token, the user ID and the user name to the system account application client, so that the client may save the information in a specific database. In this way, equivalently, the user has completed login in the system account application. Certainly, the system account application only has an account management function rather than other specific functions of playing videos, opening webpages and the like, and therefore, when in need of using these functions, the user needs to enable other applications installed in the smart TV.

S103: when the user enables a target application in the smart TV, a login status query request sent by the target application is received, a response message is returned to the target application, and the target application is notified that the current user has logged in, so that the target application acquires corresponding login information from the preset database, and completes a service request by using the login information.

That is to say, when the user needs to use functions of a target application, the user can firstly enable the application. For example, to surf the Internet, the user needs to enable the target application browser, etc. In the embodiments of the present disclosure, after a target application is enabled, if the target application only can be used under the condition that a user has logged in, it is not required that the user executes a login operation in the target application, and instead, the target application may actively query the login status of the user in the system account application. Wherein, the system account application may provide a query interface therefore for each target application in advance, so that the target application may send a query request to the system account application through the interface. For the system account application, if the query request of the target application is received, it may judge whether the user has logged in, and if yes, the status information that the user has logged in is directly returned to the target application so that the target application can acquire the login information, including the access token, the user ID, the user name and the like, in the database. In this way, each process or thread of the target application may complete specific service requests by using the login information.

Certainly, if the system account application finds out that the user has not logged in upon receiving the status query request of the target application, the system account application may directly provide the login interface for the user and remind the user of inputting the account information for logging in, and then it goes to the step S101 again to execute submission and subsequent various step operations. Equivalently, the user also can directly originate a login flow from other various target applications.

It needs to be noted that, in the embodiments of the present disclosure, various target applications generally refer to system-level applications of the smart TV or application-level applications that are developed by smart TV developers and preinstalled in the smart TV. According to the embodiments of the present disclosure, these applications may share one account system. Hence, if a user logs in by using a user name and a password registered in the system account application, and when the user needs to enable any one of these applications, the application may acquire logged-in account information through an interface to realize automatic login. That is to say, the user can directly operate in the application by using the account in the system account application without additional manual login operation in the application. When the user logs out from his/her own account, a corresponding logout instruction is sent to the user center server and the login information recorded in the database is deleted, and logout of each of the associated applications is also achieved synchronously. In addition, each target application also may include some third-party applications; certainly, if the third-party applications are associated, they equivalently give up own account systems and are uniformly managed by the account system of the smart TV to log in and log out synchronously with other applications of the smart TV. When a third-party application uses the account in the system account application in the smart TV, it needs to acquire an account interface of the system account application in advance, and when the user enables the third-party application, the third-party application may directly call the account interface of the system account application to acquire the account information in the system account application, and further complete own service flow by using the account information.

In order to provide better understanding of the technical solutions provided by the embodiments of the present disclosure, the system architecture of the embodiments of the present disclosure is described through the schematic diagram 2. It can be seen from FIG. 2 that the embodiments of the present disclosure associate the user center server with various other applications in the smart TV through the system account application. The system account application may interact with the user center server based on Http requests to execute requests such as login, logout, registration and so on. In a login status, the information such as the access token generated by the user center server further can be saved in a database of an account management framework, so that a user can directly read user information from the database and complete corresponding service flow through a system interface (for example, it can be native Account API of Android under the circumstance that the smart TV runs on the Android operating system) while using other target applications (including a cloud server, a browser, an application market, a TV version and so on).

In short, in the embodiments of the present disclosure, uniform account management can be implemented for various applications in the smart TV by using one system account application; as long as a user logs in to the system account application, the user equivalently has logged in to other associated applications synchronously. In this way, the various associated applications do not need to maintain and manage respective account systems independently, thereby saving resources; moreover, the user also does not need to remember the account information in all the applications separately and thus can use the various applications in the smart TV.

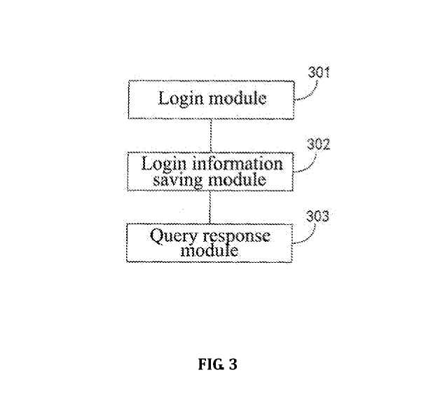

Corresponding to the account information management method in the smart TV provided by the embodiments of the present disclosure, the embodiments of the present disclosure further provide an account information management apparatus in a smart TV; referring to FIG. 3, the apparatus may include the following modules:

a login module 301 configured to, when a login request is received from a user, send account information input by the user to a user center server of a smart TV for authentication; wherein the account information includes information of a user name and a password;

a login information saving module 302 configured to, after the authentication performed by the user center server succeeds and login is completed, receive login information returned by the user center server and corresponding to the account information, and save the login information in a preset database; wherein, the login information includes information of an access token, a user ID and a user name; and

a query response module 303 configured to, when the user enables a target application in the smart TV, receive a login status query request sent by the target application, return a response message to the target application, and notify the target application that the current user has logged in, so that the target application acquires corresponding login information from the preset database, and completes a service request by using the login information.

Wherein, the apparatus further may include:

a logout module configured to, when a logout request is received from the user, send a corresponding logout instruction to a login server, i.e., the user center server to which the user has logged in, and delete the login information recorded in the database, and synchronously enable the target application to log out.

Additionally, the apparatus further includes:

a reminding module configured to, when the login status query request sent by the target application is received, and if the current status is a non-login status, provide an operation entry for the user to input the account information and remind the user of login, wherein the login information herein refers to the information input by the user while logging in, i.e., the account information input of the user.

Besides, the apparatus further includes:

a registration module configured to pre-receive a registration request and send the account information input by the user to the user center server for saving; and

a modification module configured to, when a request on modifying the account information is received, send the modified account information to the user center server for saving.

In specific implementation, the target application can be one of system-level applications of a smart TV, application-level applications preinstalled in the smart TV and third-party applications installed in the smart TV.

In short, in the apparatus provided by the embodiments of the present disclosure, uniform account management can be implemented for various applications in the smart TV by using one system account application; as long as a user logs in to the system account application, the user equivalently has logged in to other associated applications synchronously. In this way, the various associated applications do not need to maintain and manage respective account systems independently, thereby saving resources; moreover, the user also does not need to remember the account information in all the applications separately and thus can use the various applications in the smart TV.

The embodiments of the present disclosure further provide an account information management apparatus in a smart TV, comprising: one or more processors; a memory; and one or more modules stored in the memory, the one or more modules are configured to perform the following operations when being executed by the one or more processors: when a login request is received from a user, send account information input by the user to a user center server of a smart TV for authentication; wherein the account information comprises information of a user name and a password; after the authentication performed by the user center server succeeds and login is completed, receive login information returned by the user center server and corresponding to the account information, and save the login information in a preset database; wherein, the login information comprises information of an access token, a user ID and a user name; and when the user enables a target application in the smart TV, receive a login status query request sent by the target application, return a response message to the target application, and notify the target application that the current user has logged in, so that the target application acquires corresponding login information from the preset database, and completes a service request by using the login information.

Additionally, the processor is further configured to perform the following steps: when a logout request is received from the user, send a corresponding logout instruction to the user center server, and delete the login information recorded in the database, and synchronously enable the target application to log out.

Additionally, the processor is further configured to perform the following steps: when the login status query request sent by the target application is received, and if the current status is a non-login status, provide an operation entry for the user to input the account information and remind the user of login.

Additionally, the processor is further configured to perform the following steps: pre-receive a registration request and send the account information input by the user to the user center server for saving.

The embodiments of the present disclosure further provide a computer-readable recording medium on which a program for executing any method of the embodiments of the present disclosure is recorded.

The computer-readable recording medium includes any mechanism of storing or transmitting information in a computer (taking the computer as an example)-readable form. For example, a machine-readable medium includes a read-only memory (ROM), a random access memory (RAM), a magnetic disk storage medium, an optical storage medium, a flash storage memory, propagated signals in electrical, optical, acoustical or other form (i.e., carriers, infrared signals, digital signals, etc.), and the like.

With regard to all of the above-mentioned method embodiments, for the sake of simple description, all the method embodiments are expressed as a series of motion combinations; however, those skilled in the art should know that the present disclosure is not limited by the described motion order because some steps can be executed in other orders or simultaneously according to the present disclosure; secondly, those skilled in the art also should know that the method embodiments all are preferred embodiments, and motions and modules involved therein are not always necessary for the present disclosure.

With regard to all of the above-mentioned apparatus embodiments, for the sake of simple description, all the apparatus embodiments are expressed as a series of module combinations; however, those skilled in the art should know that the present disclosure is not limited by the described module combinations because some modules can be replaced by other modules according to the present disclosure; secondly, those skilled in the art also should know that the apparatus embodiments all are preferred embodiments, and the modules involved therein are not always necessary for the present disclosure.

Each embodiment in this description is described in a progressive manner, and in each embodiment, the differences between the embodiment and other embodiments are mainly explained; the same and similar parts of the various embodiments refer to each other. The system embodiments are just simply described because they are substantially similar to the method embodiments, and correlations there between just refer to one part of descriptions of the method embodiments.

The account information management method and apparatus in the smart TV provided by the present disclosure are described in detail above. Herein, specific examples are utilized to explain the principles and the implementation manners of the present disclosure, and the foregoing descriptions of the embodiments are merely used for helping to understand the method of the present disclosure and the main ideas thereof; meanwhile, for those ordinary skilled in the art, alterations will be made to the specific embodiments and the application range according to the ideas of the present disclosure; in conclusion, the contents of the description should not be understood as limitations to the present disclosure.

1. An account information management method in a smart TV, comprising:
when a login request is received from a user, sending account information input by the user to a user center server of a smart TV for authentication; wherein the account information comprises information of a user name and a password;
after the authentication performed by the user center server succeeds and login is completed, receiving login information returned by the user center server and corresponding to the account information, and saving the login information in a preset database; wherein, the login information includes information of an access token, a user ID and a user name; and
when the user enables a target application in the smart TV, receiving a login status query request sent by the target application, returning a response message to the target application, and notifying the target application that the current user has logged in, so that the target application acquires corresponding login information from the preset database, and completes a service request by using the login information.

2. The method of claim 1, further comprising:
when a logout request is received from the user, sending a corresponding logout instruction to the user center server, and deleting the login information recorded in the database, and synchronously enabling the target application to log out.

3. The method of claim 2, further comprising:
when the login status query request sent by the target application is received, and if the current status is a non-login status, providing an operation entry for the user to input the account information and reminding the user of login.

4. The method of claim 1, further comprising:
pre-receiving a registration request and sending the account information input by the user to the user center server for saving.

5. The method of claim 1, further comprising:
when a request for modifying the account information is received, sending the modified account information to the user center server for saving.

6. The method of claim 1, wherein the target application comprises a system level application of the smart TV, or an application-level application preinstalled in the smart TV, or a third-party application installed in the smart TV.

7. An account information management apparatus in a smart TV, comprising:
one or more processors;
a memory; and
one or more modules stored in the memory, the one or more modules are configured to perform the following operations when being executed by the one or more processors:
when a login request is received from a user, send account information input by the user to a user center server of a smart TV for authentication; wherein the account information comprises information of a user name and a password;
after the authentication performed by the user center server succeeds and login is completed, receive login information returned by the user center server and corresponding to the account information, and save the login information in a preset database; wherein, the login information comprises information of an access token, a user ID and a user name; and
when the user enables a target application in the smart TV, receive a login status query request sent by the target application, return a response message to the target application, and notify the target application that the current user has logged in, so that the target application acquires corresponding login information from the preset database, and completes a service request by using the login information.

8. The apparatus of claim 7, wherein the processor is further configured to perform the following steps:
when a logout request is received from the user, send a corresponding logout instruction to the user center server, and delete the login information recorded in the database, and synchronously enable the target application to log out.

9. The apparatus of claim 8, wherein the processor is further configured to perform the following steps:
when the login status query request sent by the target application is received, and if the current status is a non-login status, provide an operation entry for the user to input the account information and remind the user of login.

10. The apparatus of claim 7, wherein the processor is further configured to perform the following steps:
pre-receive a registration request and send the account information input by the user to the user center server for saving.

11. A computer-readable recording medium on which a program for executing the method of claim 1 is recorded.

12. The method of claim 2, wherein the target application comprises a system level application of the smart TV, or an application-level application preinstalled in the smart TV, or a third-party application installed in the smart TV.

13. The method of claim 3, wherein the target application comprises a system level application of the smart TV, or an application-level application preinstalled in the smart TV, or a third-party application installed in the smart TV.

14. The method of claim 4, wherein the target application comprises a system level application of the smart TV, or an application-level application preinstalled in the smart TV, or a third-party application installed in the smart TV.

15. The method of claim 5, wherein the target application comprises a system level application of the smart TV, or an application-level application preinstalled in the smart TV, or a third-party application installed in the smart TV.

16. A computer-readable recording medium on which a program for executing the method of claim 2 is recorded.

17. A computer-readable recording medium on which a program for executing the method of claim 3 is recorded.

18. A computer-readable recording medium on which a program for executing the method of claim 4 is recorded.

19. A computer-readable recording medium on which a program for executing the method of claim 5 is recorded.

20. A computer-readable recording medium on which a program for executing the method of claim 6 is recorded.
